(19) United States
(12) Patent Application Publication
(10) Pub. No.: US 2006/0268767 A1
(43) Pub. Date: Nov. 30, 2006

(54) Wireless communication system, access point management device and access point management method, wireless communication device and wireless communication method, and computer program

(75) Inventors: Hideki Sato, Kanagawa (JP); Hiroki Hashi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/415,114

(22) Filed: May 2, 2006

(30) Foreign Application Priority Data
May 9, 2005 (JP) 2005-135655

(51) Int. Cl. H04Q 7/00

(52) U.S. Cl. 370/328

(57) ABSTRACT

A wireless communication device includes: an available access point managing section managing available access point information relating to access points to which connection can be made; an access point selecting section selecting an access point to which connection is made when performing data communication with the server, on the basis of information relating to a reservable bandwidth for each of the access points, and the available access point information relating to the access points to which connection can be made; a bandwidth reservation requesting section making a request for reserving, from within a reservable bandwidth for the selected access point, a bandwidth required when performing data communication with the server; and a data communication section performing data communication with the server by using the bandwidth reserved for the access point.

### CROSS REFERS TO RELATED APPLICATIONS

The present invention contains subject matter related to Japanese Patent Application JP 2005-135655 filed in the Japanese Patent Office on May 9, 2005, the entire contents of which are incorporated herein by reference.

### BACKGROUND OF THE INVENTION

1. Field of the Invention

The present invention relates to a wireless communication system, an access point management device and an access point management method, a wireless communication device and a wireless communication method, and a computer program, which allow data transmission to be performed from a server to a wireless communication terminal via a wireless transmission line such as a wireless LAN. In particular, the present invention relates to a wireless communication system, an access point management device and an access point management method, a wireless communication device and a wireless communication method, and a computer program, which allow data provided on a server to be wirelessly transmitted to a wireless communication terminal via an access point.

More specifically, the present invention relates to a wireless communication system, an access point management device and an access point management method, a wireless communication device and a wireless communication method, and a computer program, which allow a wireless communication terminal capable of connecting to a plurality of access points to perform wireless data transmission from a server via a suitable access point. In particular, the present invention relates to a wireless communication system, an access point management device and an access point management method, a wireless communication device and a wireless communication method, and a computer program, which allow wireless data transmission to be performed via an access point that can secure a bandwidth required for data transmission a server is requested to perform by a wireless communication terminal as a client.

2. Description of the Related Art

Wireless networks have been attracting attention as systems aimed at freeing users from cumbersome wires typically required for traditional wired communication systems. Today, different wireless communication systems and wireless communication devices have been defined using frequency bands for which no license issued by regulatory authorities is required, such as 2.4 GHZ band or 5 GHz band. Examples of standards for wireless networks include IEEE (The Institute of Electrical and Electronics Engineers) 802.11, HiperLAN/2, IEEE802.15.3, and Bluetooth communication. As for the IEEE802.11 standard, due to differences in the wireless communication system or the frequency band used, various wireless communication systems exist, including IEEE802.11a standard, IEEE802.11b standard, and the like.

With the trend toward higher integration density of LSIs and lower power consumption, dramatic improvements have been made in the performance of wireless networks. Wireless networks are now widely used worldwide and currently under standardization efforts. Further, the prices of wireless LAN devices have now dropped to a level on a par with those of computer peripheral devices. Other than the traditional use as computer networks, wireless networks have found utility in a variety of applications such as connection of peripheral devices in offices and high-quality streaming video transmission between personal digital electronics at home. For example, through wireless transmission of contents such as moving pictures provided by a server installed on a wired LAN via an access point, a user carrying a wireless communication terminal can receive and enjoy the contents irrespective of the user's location.

Since a wireless network is a system in which radio waves as transmission media are shared among a plurality of wireless communication terminals, it is impossible for a plurality of terminals to use the same channel simultaneously. This becomes particularly problematic in situations where high-load communication frequently takes place, such as when a plurality of terminals perform moving picture streaming simultaneously.

For instance, in the case of IEEE802.11b, fourteen channels are provided in the 2400-2497 MHz band, which is called the ISM (Industrial Scientific and Medical) band, thereby relieving network congestion so that a greater number of wireless networks can be covered in the same area (It should be noted, however, that only three of the fourteen channels can be used simultaneously).

However, even if the frequency band that can be used within the system can be extended due to this multi-channel function, since the bandwidth available for the access point itself is limited, when many wireless communication terminals connect to one access point at a time, it may become difficult to perform high-load communication such as moving picture streaming.

In this regard, it may be possible to adopt a technique whereby an improvement in communication efficiency is achieved by installing a plurality of access points within the system.

For example, in a wireless LAN system in which a plurality of access points are installed, concentration of connections to a specific access point can be avoided by restricting the number of connecting wireless communication terminals on the access point side (see, for example, Japanese Unexamined Patent Application Publication No. 2002-185458). In this case, although it is possible to equalize and distribute the load among the plurality of access points, this does not mean that desired bandwidths can be secured on the side of the terminals connecting to the access points. That is, when there is a terminal wishing to perform moving picture streaming from the server, only the determination of the access point to which the terminal is to connect is made under the restriction of the number of connecting terminals, and it is impossible to secure the bandwidth available at the access point from the terminal side, making it necessary for the terminal to compete for available bandwidth with other terminals connected to the same access point. Further, on the access point side, how the terminal connected to the access point performs communication with the server is basically unknown.

Further, there has been proposed an access point switching system according to which, in a wireless LAN system in which a plurality of access points are installed, the access point to which a wireless communication terminal is to connect is determined on the basis of the reception quality attained by the wireless communication terminal upon connecting to each access point, thereby achieving an improvement in throughput (see, for example, Japanese Unexamined Patent Application Publication No. 2000-101596). Although in this case the access point to which the wireless terminal connects (hereinafter, referred to as the “connection access point”) can be selected on the wireless terminal side, this does not mean that the bandwidth available at the access point can be secured, even through the reception quality can be secured for the terminal. There is a possibility that a peripheral station that has also attained good reception quality may attempt to connect to the same access point. Accordingly, when a wireless communication terminal is to perform moving picture streaming from the server via an access point, the terminal has to compete for available bandwidth with other terminals connected to the same access point, which makes it difficult for the terminal to perform such high-load communication.

### SUMMARY OF THE INVENTION

It is desirable to provide superior wireless communication system, access point management device and access point management method, wireless communication device and wireless communication method, and computer program, which make it possible to perform wireless transmission of data provided on a server to a wireless communication terminal via an access point in a suitable manner.

It is also desirable to provide superior wireless communication system, access point management device and access point management method, wireless communication device and wireless communication method, and computer program, which enable a wireless communication terminal capable of connecting to a plurality of access points to perform wireless data transmission via a suitable access point in a favorable manner.

It is also desirable to provide superior wireless communication system, access point management device and access point management method, wireless communication device and wireless communication method, and computer program, which enable wireless data transmission to be performed via an access point that can secure a bandwidth required for a wireless communication terminal to perform high load transmission such as moving picture streaming.

According to an embodiment of the present invention, there is provided A wireless communication system in which a plurality of access points are installed and data provided by a server on a wired transmission line is transmitted wirelessly to a client via an access point, including: access point reservation managing means for managing access point reservation information relating to a reservable bandwidth for each of the access points; available access point managing means for managing available access point information relating to access points to which a client wishing to perform data communication with the server can connect; access point selecting means for selecting an access point to which the client connects when performing data communication with the server, on the basis of the access point reservation information relating to the reservable bandwidth for each of the access points, and the available access point information relating to the access points that can be connected to from the client; bandwidth reservation requesting means for making a reservation request to the access point reservation managing means to use, from within a reservable bandwidth for the selected access point, a bandwidth required when the client performs data communication with the server; and data communication means for performing data communication between the server and the client by using the bandwidth reserved for the access point.

It should be noted that the term “system” as used herein refers to a logical assembly of a plurality of devices (or functional modules each realizing a specific function), and it does not matter whether or not the respective devices or functional modules are present within a single casing (the same applies to the description that follows).

The wireless communication system may further include access point release requesting means for requesting, when data communication between the server and the client by the data communication means is finished, the access point reservation managing means to release the bandwidth that is reserved for the access point to perform the data communication. Further, the access point reservation managing means is configured as a host device (that is, a server for access point management) on the wired transmission line, and each client includes the available access point managing means, the access point selecting means, the bandwidth reservation requesting means, and the access point release requesting means.

According to the wireless communication system, content such as moving pictures provided by the server installed on the wired LAN can be transmitted wirelessly via the access point, and on the wireless communication terminal side as the client, the content can be received and enjoyed irrespective of the location.

It should be noted, however, that since a wireless network is a system in which radio waves as transmission media are shared among a plurality of wireless communication terminals, it is impossible for a plurality of terminals to use the same channel simultaneously. This becomes particularly problematic in situations where high-load communication frequently takes place, such as when a plurality of terminals perform moving picture streaming simultaneously.

In view of this, in the wireless communication system according to an embodiment of the present invention, under a wireless communication environment with a plurality of access points installed, the number of clients that connect to each of the access points is restricted in accordance with the bandwidth requested by each of the clients (or, depending on the case, the access point is exclusively used by a specific client), whereby high load data communication from the server to the client via the access point can be performed in a suitable manner.

That is, on the client side, while checking the usage status of each access point to which the local station can connect, the access point to connect is automatically or manually switched over in accordance with the usage bandwidth required for the data communication with the server. Accordingly, when performing high load data communication such as moving picture streaming, the client can switch over the connection to an access point that can secure a sufficient bandwidth, and during streaming processing, this access point can be exclusively used by the client, thereby making it possible to realize high load data transmission of high quality even on the wireless transmission line in which the access points are provided.

In response to the request made by the bandwidth reservation requesting means to reserve the bandwidth for the access point, the access point reservation managing means subtracts the bandwidth requested for reservation from the reservable bandwidth for the access point. That is, by reserving a bandwidth for an access point on the access point reservation information, it becomes impossible for other users to use the bandwidth reserved for the access point. In other words, the client that has made the bandwidth reservation exclusively uses the bandwidth reserved for the access point.

Further, in response to the request made by the access point release requesting means to release the bandwidth that has been reserved for the access point, the access point reservation managing means adds the released bandwidth to the reservable bandwidth for the access point. That is, by rewriting the bandwidth reserved for the access point on the access point reservation information, it becomes possible for other clients to use the bandwidth that has been reserved for the access point again, which means that the access point is released from the client that has made bandwidth reservation for the access point.

Here, the access point reservation managing means may include maximum effective speed managing means for managing a maximum effective speed with respect to each of the access points. Further, the data communication means may include communication log acquiring means for acquiring a communication log at the time of data communication between the server and the client. Further, the maximum effective speed managing means can set the maximum effective speed on the basis of a wireless transmission mode adopted by the access point, and updates the maximum effective speed in accordance with the communication log.

In this case, the access point reservation managing means subtracts the bandwidth requested to be reserved for the access point by the bandwidth reservation requesting means from one of the maximum effective speed of the access point and a current reservable bandwidth for the access point to thereby update the access point reservation information. Further, the access point reservation managing means can add the reserved bandwidth for the access point which is requested to be released by the access point release requesting means to the current reservable bandwidth for the access point to thereby update the access point reservation information.

Further, the available access point managing means may include available access point searching means for searching for access points to which the client wishing to perform data communication with the server can connect.

The access point reservation managing means provides notification access point reservation information relating to a reservable bandwidth for each of the access points, in response to a request from the available access point managing means. Further, the available access point managing means the available access point managing means manages, on the basis of the notification access point reservation information provided from the access point reservation managing means, the available access point information relating to a bandwidth available for each of the access points to which the client can connect. Further, the access point selecting means can select, on the basis of the available access point information and a bandwidth required when the client performs data communication with the server, an access point to which the client is to connect.

Further, according to an embodiment of the present invention, there is provided a computer program written in a computer-readable format, for causing access point management processing to be executed on a computer system in a wireless communication environment in which a plurality of access points are installed and data provided by a server on a wired transmission line is transmitted wirelessly to a client via an access point, the computer program causing the computer system to execute; an access point reservation management process of managing access point reservation information relating to a reservable bandwidth for each of the access points; a notification access point reservation information providing process of providing, in response to a request from the client, notification access point information relating to a reservable bandwidth for each of the access points; a first access point reservation information updating process of updating the access point reservation information in response to a bandwidth reservation request for an access point from the client; and a second access point reservation information updating process of updating the access point reservation information in response to a release request for a bandwidth reserved for an access point from the client.

The computer program according to the above-described embodiment is a computer program written in a computer-readable format and defined so as to realize predetermined processing on the computer system. In other words, by installing the computer program according to the above-described embodiment of the present invention in the computer system, a synergistic action is exerted on the computer system, so the computer program can operate as an AP management server in the wireless communication system according to the aforementioned embodiment of the present invention.

Further, according to an embodiment of the present invention, there is provided a computer program written in a computer-readable format, for executing processing causing the computer program to operate as a client on a computer system in a wireless communication environment in which a plurality of access points are installed and data provided by a server on a wired transmission line is transmitted wirelessly to a client via an access point, the computer program causing the computer system to execute; an available access point managing process of managing available access point information relating to access points to which connection can be made; an access point selecting process of selecting an access point to which connection is made when performing data communication with the server, on the basis of information relating to a reservable bandwidth for each of access points, and the available access point information relating to the access points to which connection can be made; a bandwidth reservation requesting process of making a request for reserving, from within a reservable bandwidth for the selected access point, a bandwidth required when performing data communication with the server; a data communication process of performing data communication with the server by using the bandwidth reserved for the access point; and an access point release requesting process of requesting, when data communication with the server by the data communication means is finished, release of the bandwidth that is reserved for the access point for the data communication.

The computer program according to the above-described embodiment is a computer program written in a computer-readable format and defined so as to realize predetermined processing on the computer system. In other words, by installing the computer program according to the above-described embodiment of the present invention in the computer system, a synergistic action is exerted on the computer system, so the computer program can operate as the client in the wireless communication system according to the aforementioned embodiment of the present invention.

According to the present invention, it is possible to provide superior wireless communication system, access point management device and access point management method, wireless communication device and wireless communication method, and computer program, which enable a wireless communication terminal capable of connecting to a plurality of access points to suitably perform wireless data transmission via a suitable access point.

Further, according to the present invention, it is possible to provide superior wireless communication system, access point management device and access point management method, wireless communication device and wireless communication method, and computer program, which enable a wireless communication terminal to perform wireless data transmission via an access point that can secure a bandwidth required for high load transmission such as moving picture streaming.

According to the present invention, under a wireless communication environment with a plurality of access points installed, the number of clients that connect to each of the access points is restricted in accordance with the bandwidth requested by each of the clients (or, depending on the case, the access point is exclusively used by a specific client), thereby realizing high load data communication from the server to the client via the access point.

According to the present invention, while checking the usage status of each access point that can be connected to from the client on the client side, the access point to connect is automatically or manually switched over in accordance with the usage bandwidth required for data communication with the server. Accordingly, high-load data communication such as moving picture streaming can be realized on the wireless transmission line in which the access points are provided.

While access points are generally used for the purpose of expanding the wireless LAN communication area, given the housing conditions in Japan, a single access point can often cover the entire area of a house. By setting a plurality of access points in such communication environments and restricting the number of terminals that perform high load data communication via each of the access points (that is, by distributing the connection access points in accordance with the bandwidth requested by each of the terminals), a plurality of terminals can perform high load data communication at the same time. According to this system configuration, it becomes possible for a plurality of users to enjoy moving picture streaming with the wireless terminals on their hands simultaneously and at the same location, for example.

Other objects, features, and advantages of the present invention will become apparent from the following detailed description taken in conjunction with embodiments of the present invention and the accompanying drawings.

### BRIEF DESCRIPTION OF THE DRAWINGS

FIG. 1 is a diagram schematically showing the configuration of a communication system according to an embodiment of the present invention;

FIG. 2 is a diagram showing the sequence of operations performed by a client to reserve a bandwidth for an access point through the intermediation of an AP management server to perform data streaming from a streaming server;

FIG. 3 is a flowchart showing the procedure for the processing executed by the AP management server upon activation;

FIG. 4 is a flowchart showing AP management server search processing in detail;

FIG. 5 is a flowchart showing the procedure for causing a host device on a wired LAN to operate as an AP management server;

FIG. 6 is a flowchart showing the procedure for access point reservation processing, which is performed by the AP management server in response to a bandwidth reservation request for an access point made by the client;

FIG. 7 is a flowchart showing the procedure for additionally registering a new access point record into the AP reservation list;

FIG. 8 is a flowchart showing the procedure for the processing performed by the AP management server in response to the AP reservation list acquisition request from the client;

FIG. 9 is a flowchart showing the procedure for the access point release processing executed by the AP management server in response to the access point release request from the client;

FIG. 10 is a flowchart showing the procedure for updating the maximum effective speed of the access point on the basis of a streaming log;

FIG. 11 is a flowchart showing the procedure for determining the maximum transfer rate of the access point;

FIG. 12 is a flowchart showing the procedure for the operation in a streaming server;

FIG. 13 is a flowchart showing the procedure for the operation executed by the client when performing reception of streaming;

FIG. 14 is a flowchart showing the procedure for the processing of creating the available AP list;

FIG. 15 is a flowchart showing the procedure for the processing performed by the client to make access point bandwidth reservation;

FIG. 16 is a flowchart showing the procedure for the client to select an access point that can be reserved from the available AP list;

FIG. 17 is a flowchart showing the procedure for the processing whereby the client performs streaming processing with the streaming server via an access point for which bandwidth reservation has been made;

FIG. 18 is a flowchart showing the procedure for the client to create the streaming log at the time of receiving streaming data;

FIG. 19 is a flowchart showing the procedure for the access point release processing performed on the client side for releasing access point bandwidth reservation after streaming processing is finished;

FIG. 20 is a diagram showing a modification of the communication system;

FIG. 21 is a flowchart showing the procedure for the selection processing for an access point that can be reserved, which is performed by the client in the communication system shown in FIG. 20;

FIG. 22 is a flowchart showing the procedure for a bandwidth reservation request made to the AP management server by the client in the communication system shown in FIG. 20; and

FIG. 23 is a flowchart showing the procedure for the client to connect to the access point in the communication system shown in FIG. 20.

### DESCRIPTION OF PREFERRED EMBODIMENTS

Embodiments of the present invention will now be described with reference to the drawings.

The present invention relates to a wireless communication system for performing wireless transmission of data provided on a server to a wireless communication terminal via an access point. A wired LAN such as the Ethernet (registered trademark) is assumed as the transmission line for transferring data contents on the server to the access point. Further, a wireless LAN or PAN such as the IEEE 802.11 is assumed as the wireless transmission line from the access point to the wireless communication terminal.

Networking in the IEEE802.11 is based on the concept of BSS (Basic Service Set). There are two types of BSS, including BSS that is defined in an infrastructure mode in which a master such as an access point (AccessPoint) exists, and IBSS (Independent BSS) defined in an ad-hoc mode configured solely by a plurality of wireless communication terminals (Mobile Terminals: mobile stations). Since the infrastructure mode in which a wireless communication terminal acquires data via an access point is assumed in this embodiment, description on the ad-hoc mode will be omitted.

In the BSS of the infrastructure mode, an access point (AP) for performing coordination be set up within a wireless communication system is an essential component. That is, an access point combines areas where the radio waves reach in the vicinity of the local station as a BSS, thus constituting what is referred to as a “cell” in a so-called cellular system. Each wireless communication terminal connects to one of the access points, and enters the network as a member of the BSS. An access point transmits a control signal called a beacon at suitable time intervals. A wireless communication terminal capable of receiving this beacon recognizes the presence of the access point in the neighborhood thereof, and establishes connection between the wireless communication terminal and the access point.

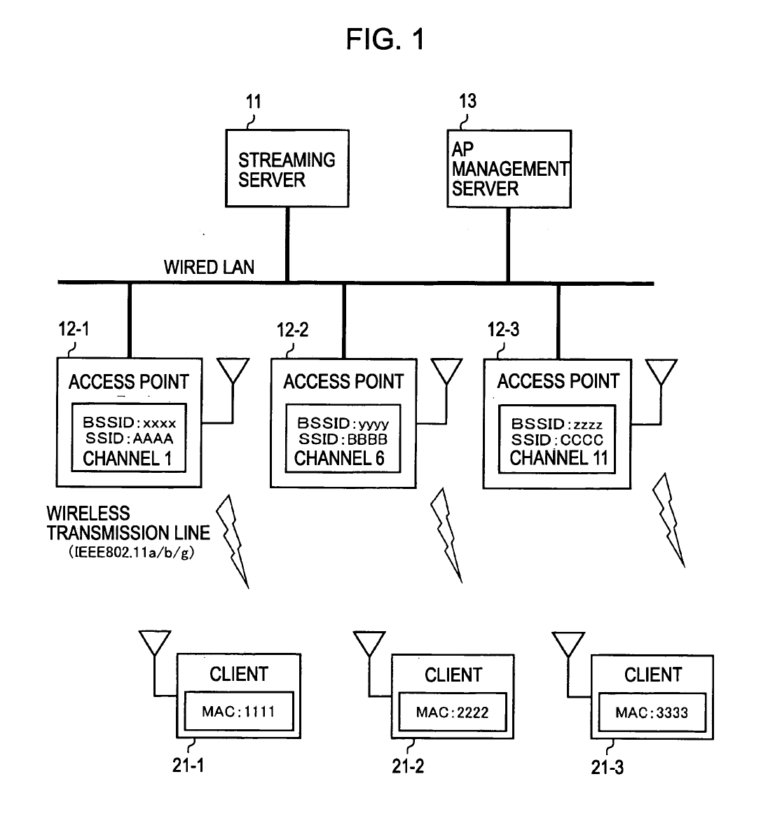

FIG. 1 schematically shows the configuration of a communication system according to an embodiment of the present invention.

In a system 10 shown in FIG. 1, there are installed, on a wired LAN, a streaming server 11 that performs streaming of moving picture data, a plurality of access points 12-1, 12-2, and 12-3 for performing wireless transmission of streaming data, which is received via the wired LAN, via a wireless transmission line defined by IEE802.11, and an AP management server 13 that manages the plurality of access points on the wired LAN. Note that while the streaming server 11 and the AP management server 13 can be configured as individual servers, it is also possible to mount these server functions on a signal device. Further, it is possible to install an information providing server (not shown) other than these servers on the wired LAN, information contents from each of the servers being distributed to the wireless communication terminals via the access points 12.

Since a wireless network is a system in which radio waves as transmission media are shared among a plurality of wireless communication terminals, it is impossible for a plurality of terminals to use the same channel simultaneously. A multi-band communication system such as the IEEE802.11b is assumed in this embodiment, and fourteen channels are provided for the 2400-2497 MHz band, thereby relieving network congestion. However, in order to avoid interference between adjacent frequency channels, it is assumed that of the fourteen channels, three orthogonal frequency channels #1, #6, and #11 are used by the three access points 12-1, 12-2, and 12-3.

Further, as identification information, each of the access points 12-1, 12-2, and 12-3 has BSSID (Basic Service Set Identifier) that can uniquely identify each access point, and SSID (Service Set Identifier) whose value becomes the same between groups connected to each other by the same distribution system.

A plurality of clients 21-1, 21-2, 21-3, and so on as wireless communication terminals are present on the wireless transmission line. Through wireless communication of contents such as moving pictures provided by the server on the LAN, users carrying the wireless communication terminals can receive and enjoy the contents irrespective of the user's location. Each of the clients 21-1, 21-2, 21-3, and so on has a unique MAC (Media Access Control) address. Within the communication system, each client is identified using this MAC address.

As described above, a plurality of frequency channels are provided over the wireless transmission line, and bandwidth expansion is accomplished by the multi-channel function. However, since the bandwidth that is available at each access point is subject to limitation, it is difficult to receive moving picture streaming from the streaming server 11 via an access point to which many clients attempt to connect at the same time.

In view of this, according to this embodiment, the number of clients 21 that connect to each of the access points 12-1, 12-2, and 12-3 is restricted through the intermediation of the AP management server 13 in accordance with the bandwidth requested by each client. For example, by allowing one access point 12 to be exclusively used by a specific client 21 attempting to perform moving picture streaming, high load data communication from the streaming server 11 to the client 21 is performed via the access point.

In order to achieve secure the bandwidth that is available at the access point 12 to which it connects, each client 21 includes an access point searching function for searching for an access point to which the local station can connect, a connection access point switching function, and an access point reserving client function for reserving the bandwidth that is available for an access point.

The client 21 finds an access point to which connection can be made from the local station by means of the access point searching function. Further, on the basis of information provided by the AP management server 13, the client 21 checks the usage status of each access point. For example, when the client 21 desires to receive moving picture streaming from the streaming server 11, the client 21 selects the access point that can reserve the usage bandwidth required for such high load data communication, and switches over the connection access point by means of the access point switching function.

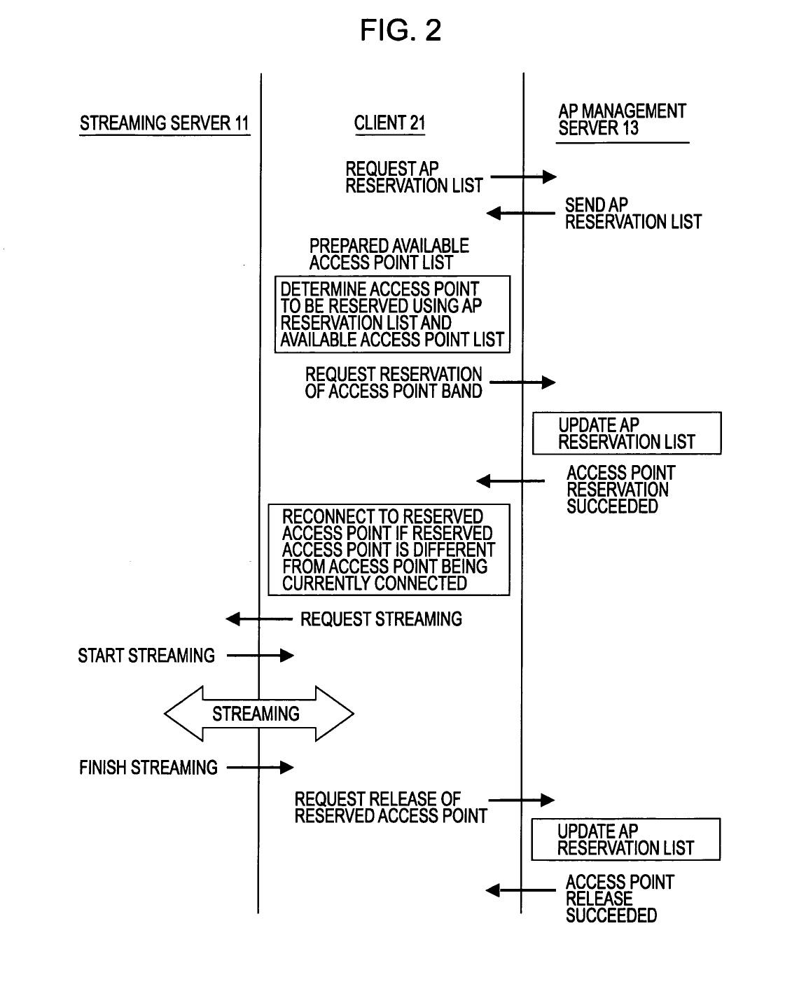

FIG. 2 shows the sequence of operations performed by the client 21 to reserve a bandwidth for an access point 12 through the intermediation of the AP management server 13 to perform data streaming from the streaming server 11.

The AP management server 13 manages an AP reservation list describing information on the maximum effective speeds of the respective access points 12-1 and so on present on the wired LAN and information on the bandwidth that has already been reserved by the connected client. The details on the structure and management method of the AP reservation list will be described later.

It is assumed that the client 21 has already been connected to either one of the access points, and can perform communication with each host on the wired LAN including the AP management server 13 via the access point. When the client 21 desires to receive data streaming from the streaming server 11, in order to select an access point that can secure a sufficient bandwidth, the client 21 requests the AP management server 13 to send the AP reservation list. In response to this request, the AP management server 13 creates a notification AP reservation list and returns it to the client.

The client 21 can find, by means of the access point searching function, access points that can be connected to from the local station, and registers these access points into a list of available APs (hereinafter, referred to as the “available AP list”). Upon receiving the AP reservation list from the AP management server 13, the client 21 compares it against the available AP list, determines the access point to which the client 21 connects for reception of streaming (i.e., determines the access point subject to bandwidth reservation), and requests the AP management server 13 for the reservation of the access point. The details on the method of creating the available AP list will be described later.

Upon receiving the reservation request from the client 21, the AP management server 13 updates information on the reserved bandwidth relating to the access point for which the reservation request has been made on the AP reservation list, and sends to the client 21 a notification confirming that the reservation of the access point is complete. When the AP management server 13 reserves a bandwidth for the access point on the AP reservation list, it becomes impossible for other clients to use the bandwidth reserved for the access point. In other words, the client 21 has exclusive use of the reserved bandwidth for the access point. The state in which the access point is exclusively used by the client 21 continues until the client 21 releases (as will be described later) the access point later.

There may be cases where the access point for which bandwidth reservation has been made by the client 21 through the above-described procedures is different from the access point to which the client 21 is currently connecting. In such a case, when starting reception of streaming from the streaming server 11, the client 21 reconnects, by means of the access point switching function, to the access point for which bandwidth reservation has been made.

Upon thus securing the connection to the access point that can use the bandwidth required for the reception of streaming, the client 21 requests the streaming server 11 for streaming of data via the access point. Then, data streaming is performed between the streaming server 11 and the client 21.

Thereafter, when the streaming of data from the streaming server 11 is finished, the client 21 requests the AP management server 13 to release the access point for which bandwidth reservation has been made.

Upon receiving the access point release request from the client 21, the AP management server 13 updates, on the AP reservation list, information on the reversed bandwidth relating to the access point for which the release request has been made, and provides to the client 21 positive acknowledgement that the access point has been released. By the AP management server 13 thus rewriting the reserved bandwidth for the access point on the AP reservation list, it becomes possible again for other clients to use the bandwidth for the access point that has been reserved. This means that the access point has been released by the client 21.

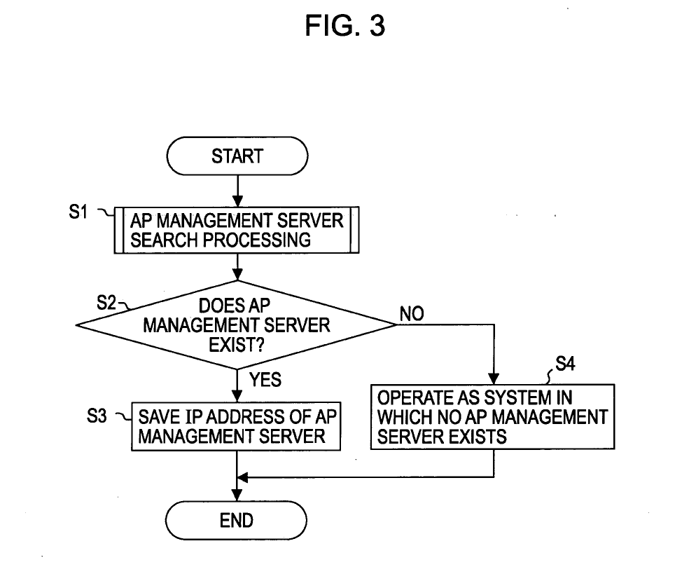

FIG. 3 is a flowchart showing the procedures executed by the AP management server 13 upon activation.

When the power of the AP management server 13 is turned on (or when a host device having the corresponding server function activates the server function), first, an AP management server search processing routine, which is separately defined, is executed (step S1), and it is checked whether or not an AP management server is already present on the wired LAN (step S2).

At this time, if an existing AP management server could be found on the wired LAN, the IP address of this AP management server is saved (step S3), and this processing routine is ended.

On the other hand, if there is no AP management server present on the wired LAN, the AP management server 13 regards the communication system as a system in which no AP management server is present, and causes itself to operate as an AP management server within the system (step S4).

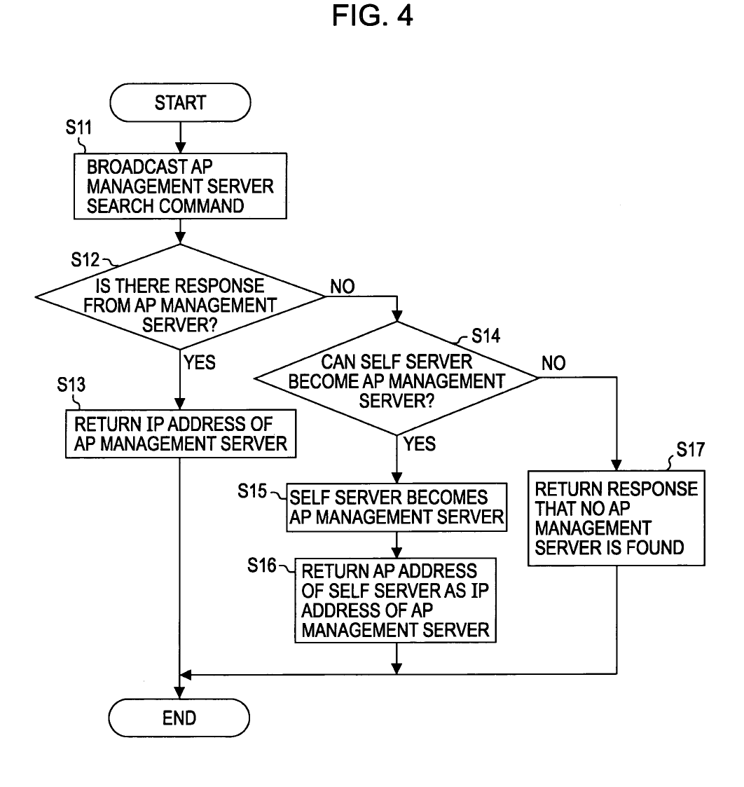

FIG. 4 is a flowchart showing in detail the procedure of the AP management server search processing executed in step S1 of the flowchart shown in FIG. 3.

First, the AP management server broadcasts an AP management server search command on the wired LAN (step S11).

At this time, when there is a response from an AP management server (step S12), the IP address of the AP management server is returned (step S13), and the whole processing routine is ended.

On the other hand, where there is no response from an AP management server, it is checked whether or not the self server can serve as the AP management server for the communication system (step S14). If it is determined that the self server can serve as the AP management server, the self server becomes the AP management server (step S15), and the IP address of the self server is returned as the IP address of the AP management server (step S16). Further, if it is determined that the self server cannot serve as the AP management server, a response indicating that no AP management server is found is returned (step S17), and this processing routine is ended.

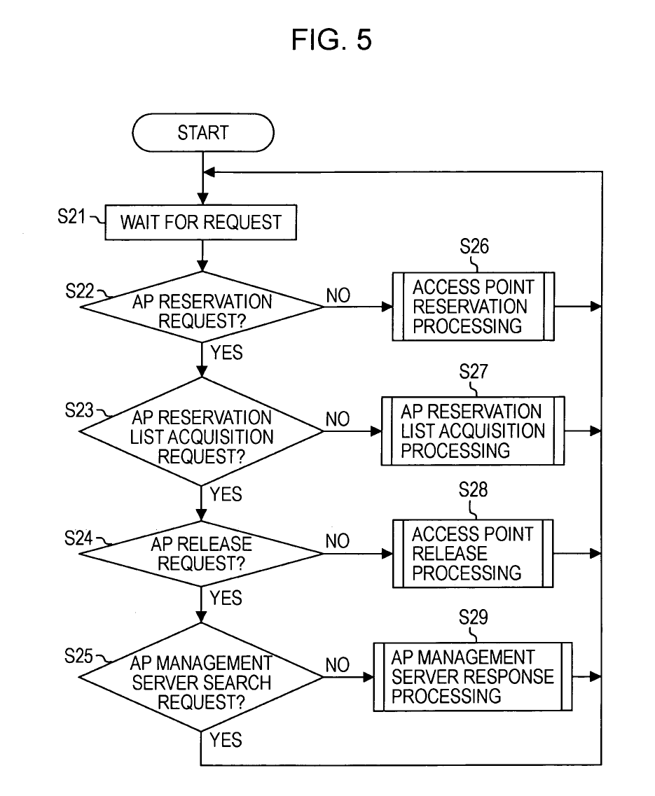

FIG. 5 is a flowchart showing the procedure for causing a host device on the wired LAN to operate as an AP management server.

The AP management server waits for a request from a client (step S21).

Upon receiving an access point bandwidth reservation request from the client via an access point (step S22), the AP management server activates access point reservation processing that has been separately defined (step S26).

Further, upon receiving an access point reservation list acquisition request from the client via the access point (step S23), the AP management server activates access point reservation list acquisition processing that has been separately defined (step S27).

Further, upon receiving a request via the access point for releasing the access point for which bandwidth reservation is being made (step S24), the AP management server activates access point release processing that has been separately defined (step S28).

Further, upon receiving an AP management server search request from another host device (step S25), the AP management server activates access point management server response processing that has been separately defined (step S29).

The AP management server holds an AP reservation list as shown in the table below, and manages information on the SSID and BSSID, and maximum effective speed [Mbps] of each access point, and the MAC address of the client that is making bandwidth reservation and the reserved bandwidth [Mbps].

TABLE 1

| | | Maximum | | Reserved |
|---|---|---|---|---|
| | | Effective | MAC address of | bandwidth |
| ESSID | BSSID | Speed [Mbps] | client | [Mbps] |
| AAAA | aaaa | 4 | 1111 | 4 |
| BBBB | bbbb | 4 | 2222 | 2 |
| CCCC | cccc | 4 | 3333 | 1 |
| DDDD | dddd | 4 | 4444 | 2 |

It should be noted that the AP management server does not manage on the AP reservation list the bandwidth reservation statuses of all the access points installed on the wired LAN; the AP reservation list includes entries of only those access points for which bandwidth reservation has been made upon request from the clients. The record of an access point having all of its available bandwidth released by the client is deleted from the AP reservation list.

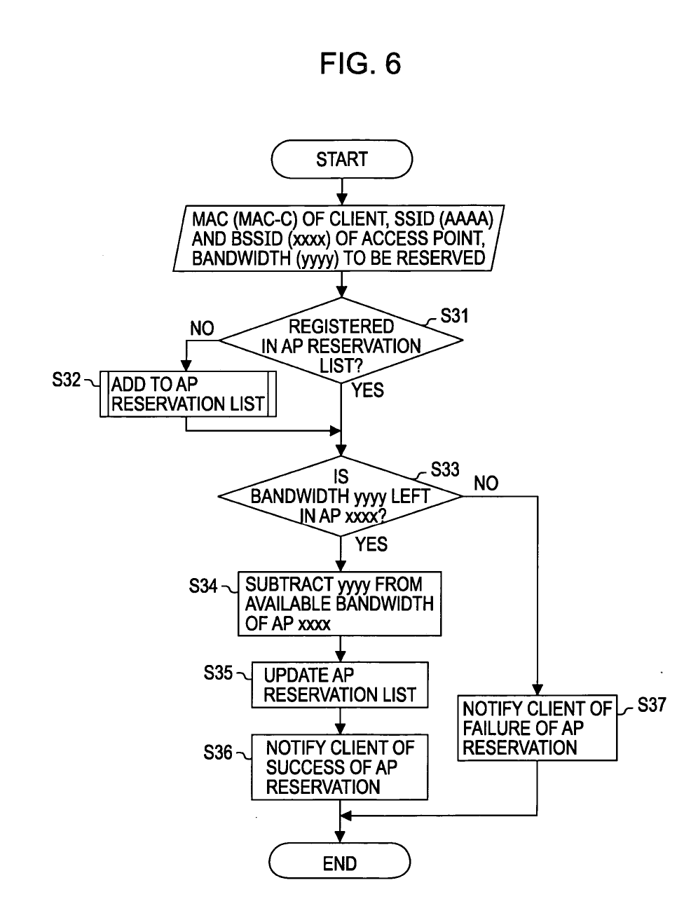

FIG. 6 is a flowchart showing the procedure for access point reservation processing, which is performed by the AP management server 13 in response to a bandwidth reservation request for an access point made by the client 21.

The MAC address of the client itself, the SSID (provisionally indicated as AAAA) and BSSID (provisionally indicated as xxxx) of the access point for which bandwidth reservation is to be made, and the bandwidth (provisionally indicated as yyyy) desired to be reserved, are written in the bandwidth reservation request for an access point from the client 21.

Upon receiving the bandwidth reservation request from the client 21, the AP management server 13 refers to the AP reservation list to check whether or not the access point for which bandwidth reservation is requested has already been registered in the AP reservation list (step S31). At this time, if it is determined that the access point has not been registered, a processing routine that has been separately defined is called up to create a record of the access point, and this is registered into the AP reservation list (step S32).

Then, the AP management server 13 refers to the AP reservation list to check whether or not the bandwidth yyyy, for which reservation request has been made by the client 21, can be used on the access point that is the bandwidth reservation destination (step S33).

If the result of this check is affirmative, the AP management server subtracts the reserved bandwidth yyyy from the available bandwidth (step S34), and updates the AP reservation list (step S35). Then, the AP management server gives to the client 21 originating the reservation request a notification indicating the completion of the bandwidth reservation for the access point (step S36).

On the other hand, if it is determined that the bandwidth yyyy, for which the reservation request has been made by the client 21, cannot be used on the access point that is the bandwidth reservation destination (step S33), the AP management server 13 gives to the client 21 originating the request a notification indicating the failure of the bandwidth reservation for the access point (step S37).

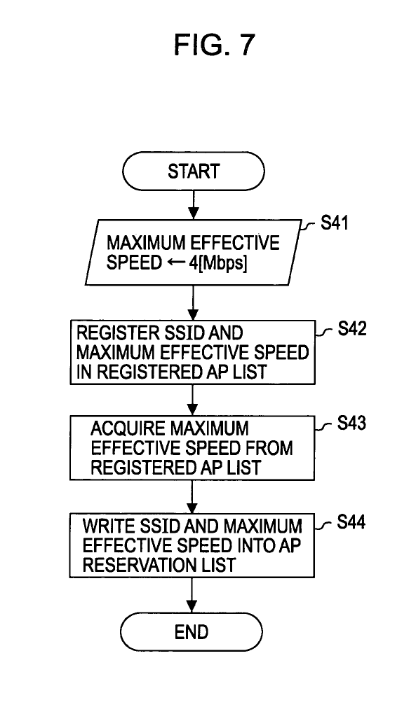

FIG. 7 is a flowchart showing the procedure for the processing of additionally registering a new access point record into the AP reservation list, which is activated in step S32 of the flowchart shown in FIG. 6.

First, 4 [Mbps] as a default value is substituted into the maximum effective speed field (step S41), and then the SSID and maximum effective speed are registered into the record of the corresponding access point in the registered AP list (step S42).

Next, the maximum effective speed is acquired from the registered AP list (step S43). Then, the SSID and the maximum effective speed are written into the record of the corresponding access point in the AP reservation list (step S44), and this processing routine is ended.

As has been already described above, the AP management server 13 manages, on the AP reservation list shown in Table 1, information such as the SSID, BSSID, maximum effective speed, and reserved bandwidth relating to each of the access points 12-1, 12-2, and 12-3 that are subject to bandwidth reservation by each of the clients 21 in the communication system. Further, on the client 21 side, in order to find the access point that can secure the bandwidth required for the communication for the local station and switch over the connection to that access point, information on the available bandwidth for each of the access points 12-1, 12-2, and 12-3 is necessary. Accordingly, the client 21 requests the AP management server 13 to send the AP reservation list, and the AP management server 13 returns the AP reservation list to the client 21 (see FIG. 2).

At this time, the AP management server 13 does not send the AP reservation list shown in Table 1 as it is. Instead, the AP management server 13 creates a notification AP reservation list, which describes the available bandwidth for each of the access points 12-1, 12-2, and 12-3 required on the client 21 side in an easy-to-reference format, and provides this notification AP reservation list to the client 21. The table below shows a configuration example of the notification AP reservation list. This table describes identification information such as SSID and BSSID and available bandwidth information, which becomes necessary at the time of switching connections on the client 21 side, with respect to each of the entries of the access points 12-1, 12-2, and 12-3 in the management AP reservation list shown in Table 1. The available bandwidth as specified herein can be determined by subtracting a bandwidth already reversed by either of the clients from the maximum effective speed of the access point described on the management AP reservation list.

TABLE 2

| | | Available bandwidth [Mbps] |
|---|---|---|
| | | (Maximum effective speed − |
| ESSID | BSSID | reserved bandwidth) |
| AAAA | aaaa | 0 |
| BBBB | bbbb | 2 |
| CCCC | cccc | 3 |

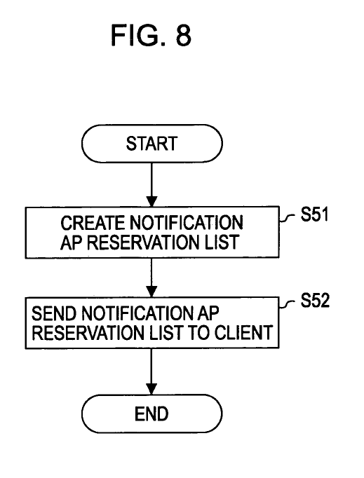

FIG. 8 is a flowchart showing the procedure for the processing performed by the AP management server 13 in response to the AP reservation list acquisition request from the client 21.

First, the AP management server 13 determines the available bandwidth for each of the entries of the access points 12-1, 12-2, and 12-3 in the management AP reservation list by subtracting a bandwidth already reserved by either of the clients from the maximum effective speed, and creates a notification AP reservation list including a record of each access point describing the available bandwidth together with the SSID and BSSID (step S51).

Then, the AP management server 13 sends this notification AP reservation to the client 21 originating the request (step S52), and this processing routine is ended.

When performing high load data communication, such as during moving picture streaming from the streaming server 11, the client 21 makes bandwidth reservation for the access point, whereby the client 21 exclusively uses the reserved bandwidth to thereby secure desired quality of communication. Further, when the high-load communication has been completed, the client 21 releases the access point's bandwidth that has been reserved, thus allowing other clients to use that access point again.

The access point release processing is activated by the client 21 issuing an access point release request to the AP management server 13. At this time, the AP management server 13 rewrites the reservable bandwidth for the access point on the management AP reservation list (see Table 1), thus making it possible for other clients to use the bandwidth of the access point that has been reserved again.

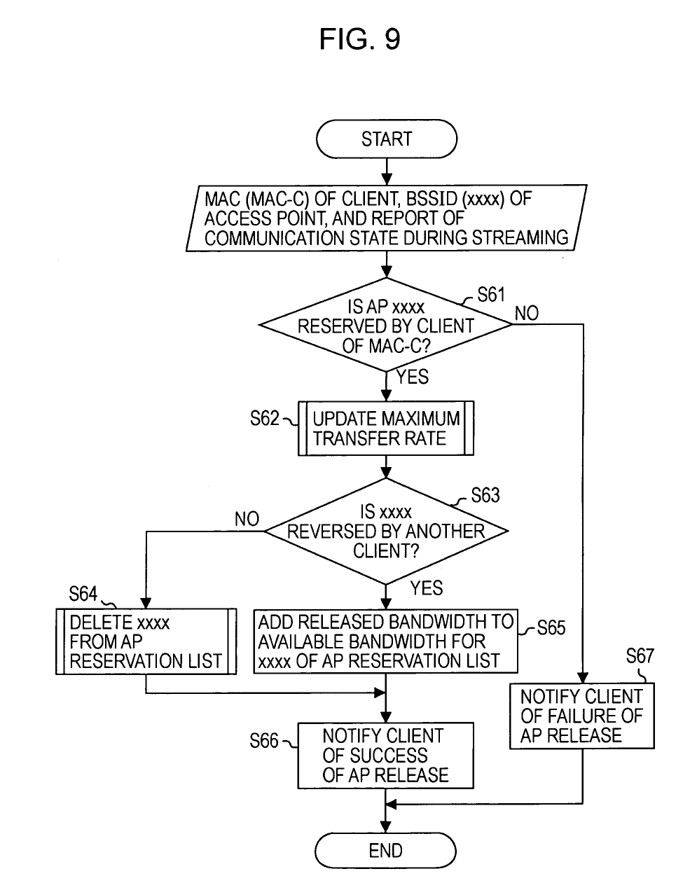

FIG. 9 is a flowchart showing the procedure for the access point release processing executed by the AP management server 13 in response to the access point release request from the client 21.

The access point release request from the client describes the following: the MAC address (provisionally indicated as MAC-C) of the client 21, the BSSID (provisionally indicated as xxxx) of the access point for which a bandwidth is to be released, and a “streaming log (StreamingLog)” as the report of the communication state during the streaming (which will be described later).

Upon receiving the access point release request from the client 21, the AP management server 13 checks on the management AP reservation list whether or not the access point identified by its BSSID “xxxx” has been actually reserved by the client 21 of MAC-C (step S61).

Next, the AP management server 13 activates a maximum effective speed updating routine that has been separately defined, calculates the maximum effective speed of the access point using the streaming log (step S62), and updates the effective maximum speed of the corresponding record in the management AP reservation list.

Next, the AP management server 13 checks, on the management AP reservation list, whether or not the bandwidth of the access point has been reserved by another client (step S63). At this time, if it is determined that the access point has been reserved by none of the clients, the record of the corresponding access point is deleted from the management AP reservation list (step S64). Further, if it is determined that the bandwidth of the access point has been reserved by any another client, the bandwidth released by the client 21 originating the request is added to the available bandwidth of the corresponding record in the management AP reservation list (step S65). After the management AP reservation list is updated in this way, a notification indicating the success of the release of the access point is given to the client 21 originating the request (step S66), and this processing routine is ended.

By the AP management server 13 thus rewriting the reserved bandwidth for the access point on the AP reservation list, it becomes possible again for other clients to use the bandwidth of the access point that has been reserved. This means that the access point has been released by the client 21.

On the other hand, if it could not be confirmed on the management AP reservation list that bandwidth reservation has been actually made for the access point identified by the BSSID “xxxx” by the client 21 of MAC-C (step S61), the AP management server 13 gives to the client 21 originating the request a notification indicating the failure of the requested release of the reserved bandwidth for the access point (step S67).

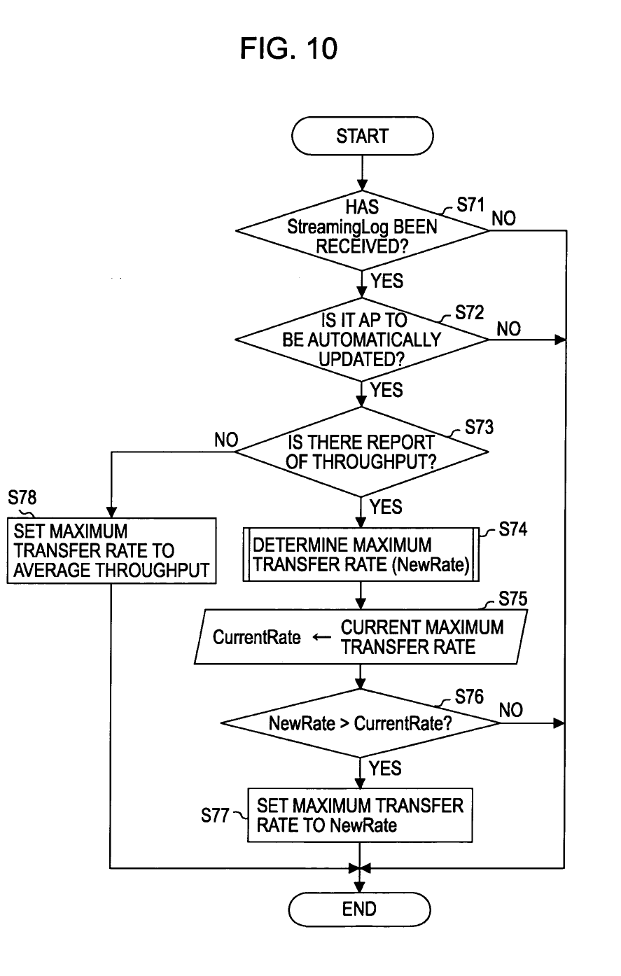

FIG. 10 is a flowchart showing the procedure for the processing of updating the maximum effective speed of the access point on the basis of the streaming log, which is performed in step S62 of the flowchart shown in FIG. 9.

First, it is checked whether or not the streaming log has been received (step S71), and then it is checked whether or not the access point is an access point that is to be automatically updated (step S72). Then, it is checked whether or not a report of throughput is included in the streaming log (step S73).

If the report of throughput is not included in the streaming log, the maximum transfer rate NewRate is determined by a processing routine that has been separately defined (step S74), and is substituted into the current transfer rate CurrentRate (step S75). At this time, the maximum transfer rate NewRate determined in step S74 and the current maximum transfer rate CurrentRate are compared against each other in terms of size (step S76). If it is determined that NewRate is larger than CurrentRate, the maximum transfer rate of the access point is set to NewRate (step S77).

On the other hand, if the report of throughput is included in the streaming log (step S73), the maximum transfer rate of the access point is set to the average throughput (step S78).

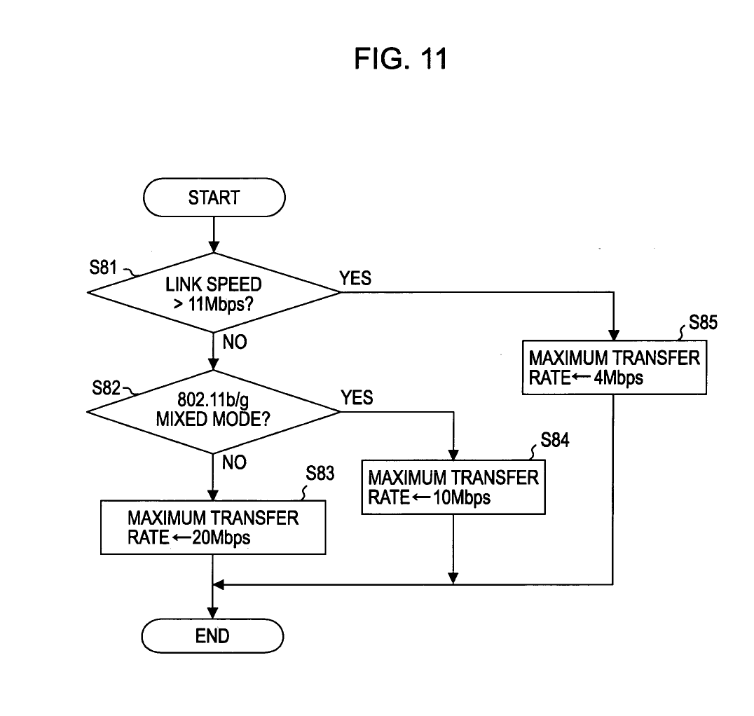

FIG. 11 is a flowchart showing the procedure for the processing of determining the maximum effective speed of the access point, which is performed in step S74 of the flowchart shown in FIG. 10.

First, it is checked whether or not the link speed is below 11 Mbps (step S81). If the link speed is below 11 Mbps, it is assumed that the wireless transmission line between the access point 12 and the client 21 is that of a wireless network specified by IEEE802.11B. Accordingly, the maximum transfer rate of the access point 12 is determined to be 4 Mbps (step S85).

On the other hand, if the link speed is equal to or larger than 11 Mbps, it is checked whether or not the wireless transmission line between the access point 12 and the client 21 is that of a mixed operation mode in which IEEE802.11b and IEEE802.11b coexist (step S82). At this time, in IEEE802.11g, a high speed of 20 Mbps or more is attained while securing compatibility with IEEE802.11 and IEEE802.11b that operate at the 2.4 GHz band.

In the case of the mixed mode of IEEE802.11b and IEEE802.11b, the maximum transfer rate of the access point 12 is set to 10 Mbps (step S84). Further, when the operation mode is not the mixed mode, that is, when it is the IEEE802.11g mode, the maximum transfer rate of the access point 12 is set to 20 Mbps (step S83).

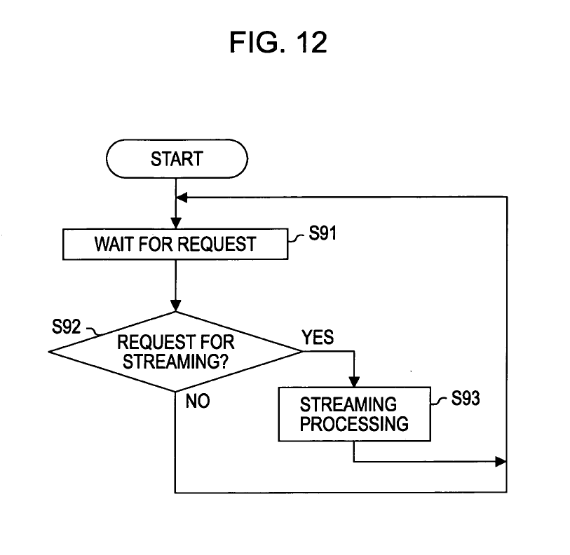

When receiving moving picture streaming from the streaming server 11, the client 21 switches the connection to an access point for which sufficient bandwidth is available. Then, upon receiving a streaming request via the access point, the streaming server 11 starts data streaming between it and the client 21 via the access point. FIG. 12 is a flowchart showing the procedure for the operation in the streaming server 11.

The streaming server 11 waits on standby for the reception of a streaming request on the wired LAN (step S91). Upon receiving the streaming request (step S92), the streaming server 11 executes streaming processing for the specified data with respect to the client 21 originating the request (step S93).

While the above description is directed to the case of the client 21 that is connected via an access point, it is a matter of course that the streaming processing can be likewise performed by the streaming server 11 with respect to a client on the wired LAN.

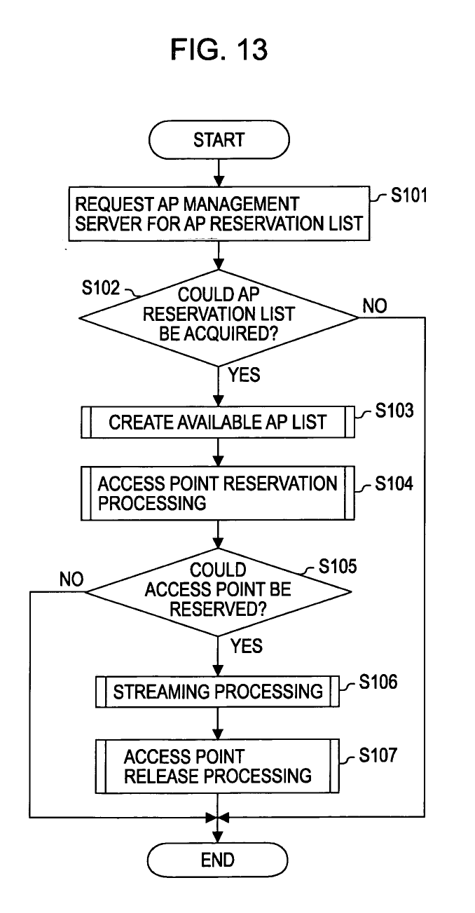

According to this embodiment, through the intermediation of the AP management server 13, the client 21 on the wireless transmission line switches over the access point to which the client 21 connects in accordance with the usage bandwidth required for the data communication with the streaming server 11, while checking the usage status of each access point that can be connected to from the local station. In this way, high-load data communication such as moving picture streaming can be realized on the wireless transmission line in which the access points are provided. FIG. 13 is a flowchart showing the procedures of the operation executed by the client 21 when performing reception of streaming.

First, the client 21 requests the AP management server 13 to send the AP reservation list (step S101). The client 21 can send the request to the AP management server 13 via the access point to which the client 21 is currently connecting.

On the AP management server 13 side, with respect to each of the entries of the access points 12-1, 12-2, and 12-3 in the management AP reservation list (see Table 1), the available bandwidth is determined by subtracting a bandwidth already reversed from the maximum effective speed, and the notification AP reservation list (see Table 2) including a record for each access point describing the SSID and BSSID and also the available bandwidth is created. The AP management server 13 then returns the notification AP reservation list to the client 21 originating the request (refer to the aforementioned description and FIG. 8).

Upon successfully receiving the notification AP reservation list from the AP management server 13 (step S102), the client 21 creates, through a processing routine that has been separately defined, the available AP list including information on the access points available to the local station (step S103).

Next, the client 21 performs, through a processing routine that has been separately defined, access point reservation processing on the basis of the notification AP reservation list acquired from the AP management server 13 and the list of available APs for the local station (step S104). Since the bandwidths that are available at the respective access points 12-1, 12-2, and 12-3 can be found from the notification AP reservation list, the access points with which the client 21 can perform communication can be found from the available AP list. Thus, by referring to both the lists, it is possible to identify the access point capable of communicating with the client 21 and using a bandwidth sufficient for performing moving picture streaming.

When, through the above-described procedure, the client 21 has successfully reserved the access point to which it connects for moving picture streaming (step S105), the client 21 executes streaming processing with the streaming server 11 through a processing routine that has been separately defined (step S106).

Thereafter, if the bandwidth for the connection access point remains reserved as it is after the data streaming from the streaming server 11 is finished, this results in the wastage of communication resources. Accordingly, the client 21 executes, through a processing routine that has been separately defined, the processing of releasing the bandwidth reservation for the access point (step S107). When the access point release processing is performed, it becomes possible again for other clients to use the bandwidth of the access point that has been reserved.

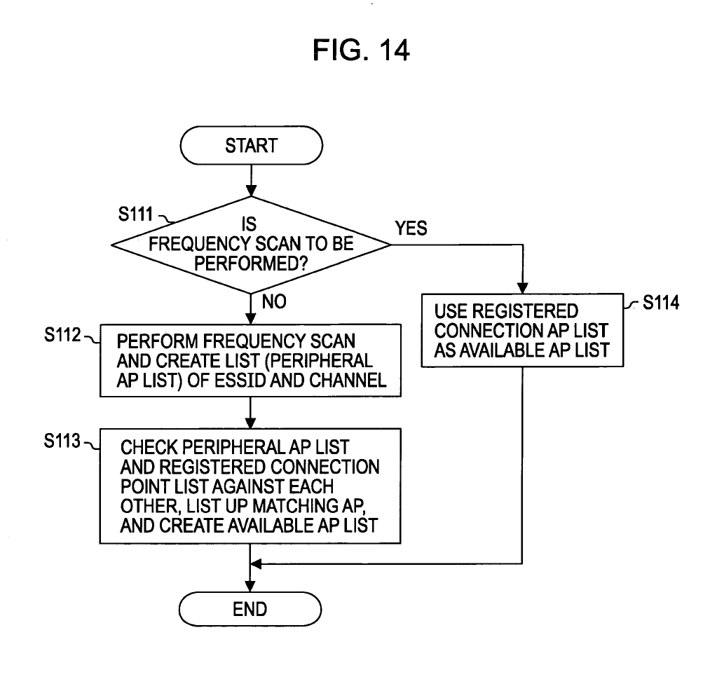

FIG. 14 is a flowchart showing the procedure for the processing of creating the available AP list, which is executed in step S103 of the flowchart shown in FIG. 13.

In the case of a setting where a frequency scan is performed when creating the available AP list (step S111), the client 21 performs the frequency scan on the wireless transmission line, and attempts to receive beacons transmitted from access points. Then, by acquiring the SSIDs and the usage channels of the access points from the received beacons, the client 21 creates a list of peripheral APs (hereinafter, referred to as the “peripheral AP list”) describing the SSID, the usage channel, and the field intensity relating to each of the access points 12-1, 12-2, and 12-3 that are present within the receivable range of the local station (step S112). The following shows a configuration example of the peripheral AP list.

TABLE 3

| | | | Field |
|---|---|---|---|
| ESSID | BSSID | Channel | intensity [%] |
| AAAA | aaaa | 1 | 80 |
| BBBB | bbbb | 6 | 100 |
| CCCC | cccc | 11 | 70 |
| ABC | abca | 1 | 50 |
| EFG | efef | 6 | 70 |
| XYG | aedea | 11 | 70 |

Next, the peripheral AP list and the registered connection AP list are checked against each other to list up matching access points, thus creating the available AP list (step S113). A configuration example of the registered connection AP list is shown below. An encryption key, which is used to offer a level of security equivalent to that of a wired transmission line on a wireless transmission line by secret key cryptography, is written in the field of the “WEP (Wired Equivalent Privacy)”. Further, the “priority” is used in the case where a plurality of access points are present for the same ESSID (which will be described later).

TABLE 4

| ESSID | BSSID | WEP | Priority |
|---|---|---|---|
| AAAA | aaaa | ***** | 0 |
| AAAA | abab | ***** | 1 |
| AAAA | baba | ***** | 0 |
| BBBB | bbbb | ***** | 1 |
| CCCC | cccc | ***** | 1 |

By checking the peripheral AP list and the registered connection AP list against each other, the client 21 can acquire information on the SSID, BSSID, usage channel, and field intensity of each of the access points 12-1, 12-2, and 12-3 that can be connected to from the local station. These information are listed up in the available AP list. The following shows a configuration example of the available AP list.

TABLE 5

| | | | Field |
|---|---|---|---|
| ESSID | BSSID | Channel | intensity [%] |
| AAAA | aaaa | 1 | 80 |
| BBBB | bbbb | 6 | 100 |
| CCCC | cccc | 11 | 70 |

On the other hand, in the case of a setting in which no frequency scan is performed when creating the available AP list (step S111), the registered connection AP list (see Table 4) is used as the available AP list as it is (step S114).

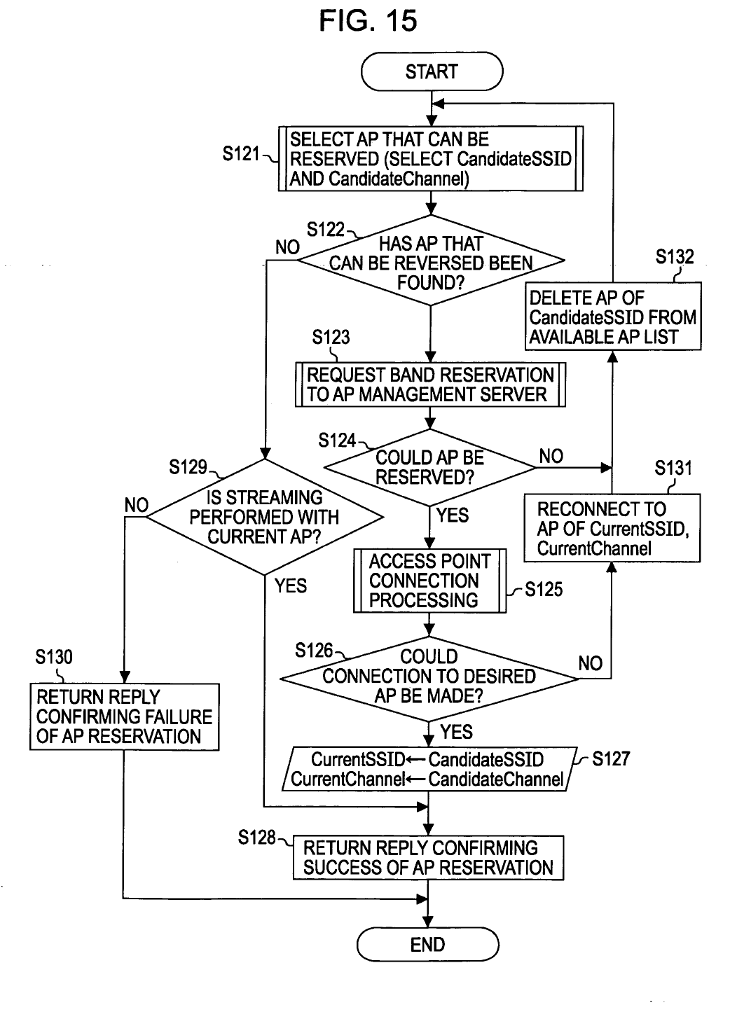

FIG. 15 is a flowchart showing the procedure for the processing performed by the client 21 to make access point bandwidth reservation, which is executed in step S104 of the flowchart shown in FIG. 13.

First, the client 21 selects, through a processing routine that has been separately defined, an access point for which bandwidth reservation can be made by the client 21 (step S121). Through this processing routine, the SSID and usage channel (CandidateSSID and CandidateChannel) of the candidate access point can be obtained as return values.

Then, if an access point that can be reserved could be found (that is, if the CandidateSSID and CandidateChannel could be found) (step S122), then the client 21 makes a bandwidth reservation request for the access point to the AP management server 13 (step S123).

The client 21 makes the bandwidth reservation request to the AP management server 13 by designating the SSID (that is, CandidateSSID) of and the desired bandwidth for the access point. In response to this, the AP management server 13 performs the reservation processing (as previously described) for the access point through the procedure shown in FIG. 6.

If, as a result of the reservation request, a desired access point could not be reserved by the client 21 (step S124), the record of this access point (that is, the access point with CandidateSSID) is deleted from the available AP list (step S132). The process returns to step S121 where the processing of selecting an access point that can be reserved is performed again.

On the other hand, if, as a result of the reservation request, a desired access point could be reserved by the client 21 (step S124), then the client 21 makes a connection to the candidate access point (that is, the access point with CandidateSSID) (step S125).

The connection to the access point is performed by the client 21 transmitting a connection request while designating the SSID and the encryption key (such as WEP key or WPA-PSK) with respect to the access point.

At this time, if the client 21 could not connect to the desired access point (that is, the access point with CandidateSSID) (step S126), the client 21 reconnects to the access point to which it has been connected (that is, the access point with CurrentSSID and CurrentChannel) (S131), and the record of this access point (that is, the access point with CandidateSSID) is deleted from the available AP list (step S132). The process then returns to step S121 where the processing of selecting an access point that can be reserved is performed again.

If the client 21 could connect to the desired access point (that is, the access point with CandidateSSID) (step S126), the desired access point is set as the current access point (that is, CandidateSSID is substituted into CurrentSSID, and CandidateChannel is substituted into CurrentChannel) (step S127). Then, a response indicating the successful completion of the access point reservation processing is returned to the client that has called up the processing routine (step S128), and this processing routine is ended.

Further, if, in the processing routine for selecting an access point that can be reserved (step S121), an access point that can be reserved could not be found (step S122), a determination is made whether or not to perform streaming via the currently connected access point (step S129). If the streaming is performed via the currently connected access point, a response indicating the successful completion of the access point reservation processing is returned to the client that has called up the processing routine (step S128), and this processing routine is ended. If the streaming is not performed using the currently connected access point, a response indicating the failure of the access point reservation processing is returned to the client that has called up the processing routine (step S130), and this processing routine is ended.

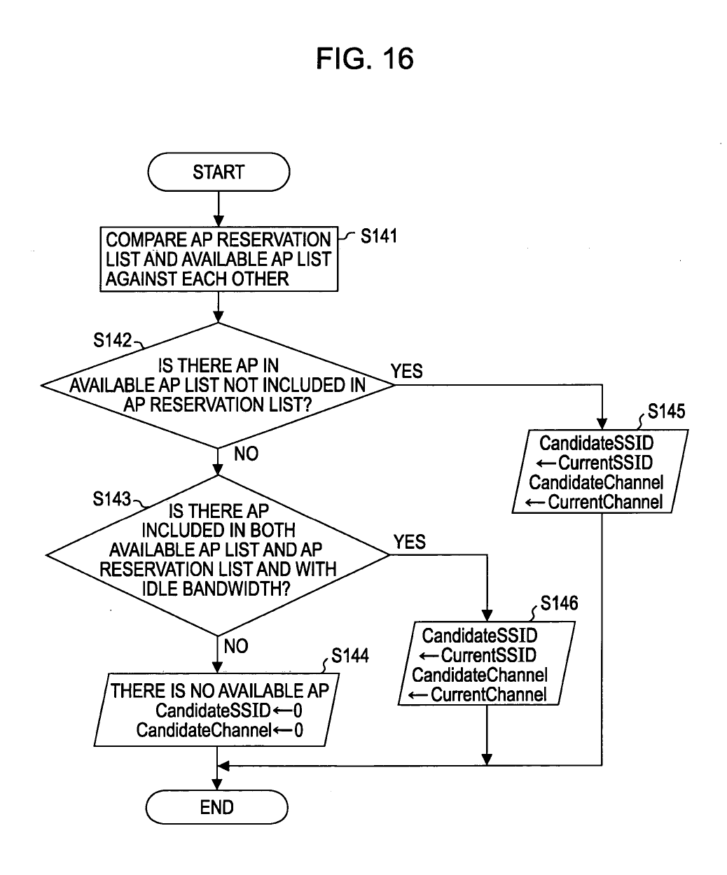

FIG. 16 is a flowchart showing the procedure for the client 21 to select an access point that can be reserved from the available AP list, which is performed in step S121 of the flowchart shown in FIG. 15.

First, the client 21 compares the notification AP reservation list (see Table 2) acquired from the AP management server 13 against the available AP list (see Table 5) created by the local station through the procedure shown in FIG. 14 (step S141). Then, it is checked whether or not a record of an access point for which there is no entry in the notification AP reservation list is present in the available AP list (step S142).

At this time, if the available AP list includes a record of an access point for which there is no entry in the notification AP reservation list, this access point is set as the reservation candidate access point (that is, CurrentSSID is substituted into CandidateSSID, and the found channel is substituted into CandidateChannel) (step S145), and with this as a return value returned to the client that has requested the processing routine, this processing routine is ended.

If the record of an access point for which there is no entry in the notification AP reservation list could not be found in the available AP list (step S142), then it is checked whether or not there is an access point included in both of the available AP list and the notification AP reservation list but having extra idle available bandwidth (step S143).

If an access point with extra idle available bandwidth could be found from the notification AP reservation list, the access point is set as the reservation candidate access point (that is, CurrentSSID is substituted into CandidateSSID, and the found channel is substituted into CandidateChannel) (step S146), and with this as a return value returned to the client that has called up the processing routine, this processing routine is ended.

On the other hand, if an access point that can secure a sufficient bandwidth for performing streaming processing could not be found from the notification AP reservation list (step S143), the available access point=0 (that is, CurrentSSID and 0 are substituted into CandidateSSID and CandidateChannel, respectively) is returned as a return value to the client that has called up the processing routine (step S144), and this processing routine is ended.

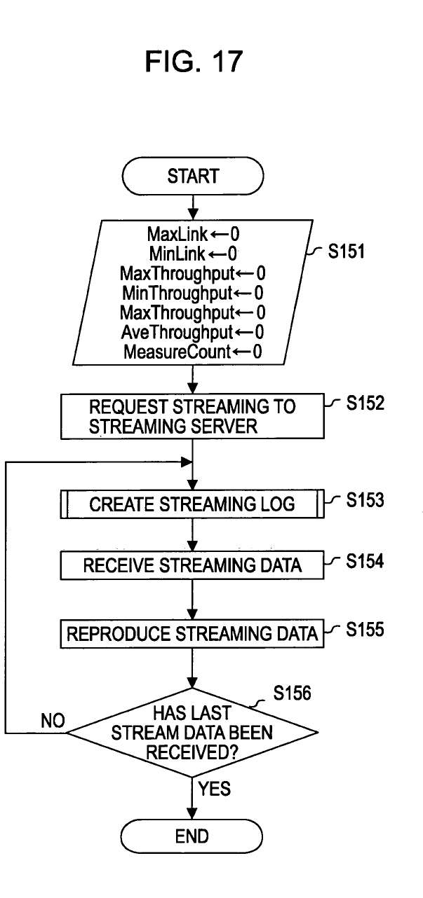

FIG. 17 is a flowchart showing the procedure for the processing whereby the client 21 performs streaming processing with the streaming server 11 via an access point for which bandwidth reservation has been made, which is performed in step S106 in the flowchart shown in FIG. 13.

First, the client 21 substitutes an initial value to each of the variables used for creating the streaming log (step S151), and requests the streaming server 11 to perform streaming via the access point for which bandwidth reservation has been made (step S152). Examples of the variables used include the maximum link speed (MaxLink), the minimum link speed (MinLink), the maximum throughput (MaxThroughput), the average throughput (AverageThroughtput), the minimum throughput (MinThroughput), and the measurement count (measureCount). Subsequently, the streaming log is created through a processing routine that has been separately defined (step S153).

Then, the client 21 receives the streaming data from the streaming server 11 (step S154), and performs reproduction processing of the streaming data (step S155).

While receiving data from the streaming server 11 (step S156), the client 21 repeats the processing of creating the streaming log, and receiving and reproducing the streaming data.

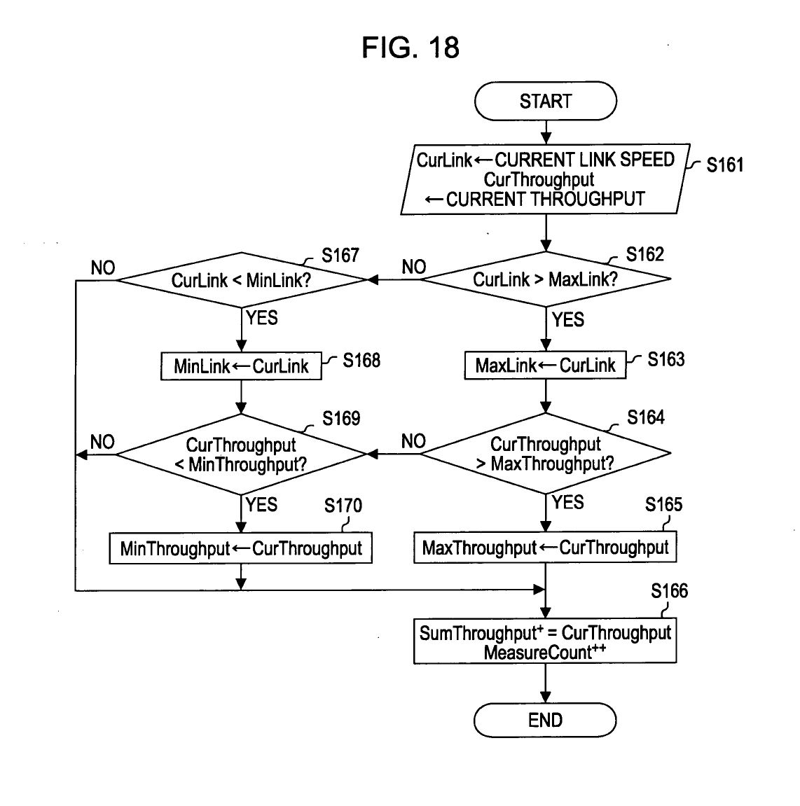

FIG. 18 is a flowchart showing the procedure for the processing for the client 21 to create the streaming log at the time of receiving streaming data, which is executed in step S153 of the flowchart shown in FIG. 17.

First, the current link speed is substituted into a variable CurLink, and the current throughput is substituted into CurThroughput (step S161).

Next, CurLink and MaxLink are compared in terms of size (step S162). If CurLink is larger, Curlink is substituted into MaxLink, and the maximum link speed is updated (step S163).

Next, CurThroughput and MaxThroughput are compared in terms of size (step S164). If CurThroughput is larger, CurThroughput is substituted into MaxThroughput, and the maximum throughput is updated (step S165).

Further, if CurLink is not larger that MaxLink, then CurLink and MinLink are compared in terms of size (step S167). If CurLink is smaller, Curlink is substituted into MinLink, and the minimum link speed is updated (step S168).

After the minimum link speed is updated, if CurThroughput is not larger than MaxThroughput (step S164), then CurThroughput and MinThroughput are compared in terms of size (step S169). If CurThroughput is smaller, CurThroughput is substituted into MinThroughput, and the minimum throughput is updated (step S170).

Then, the sum of throughputs SumThroughput is added to the current throughput CurThroughput, and the measurement count MeasureCount is incremented (step S166), and this processing routine is ended.

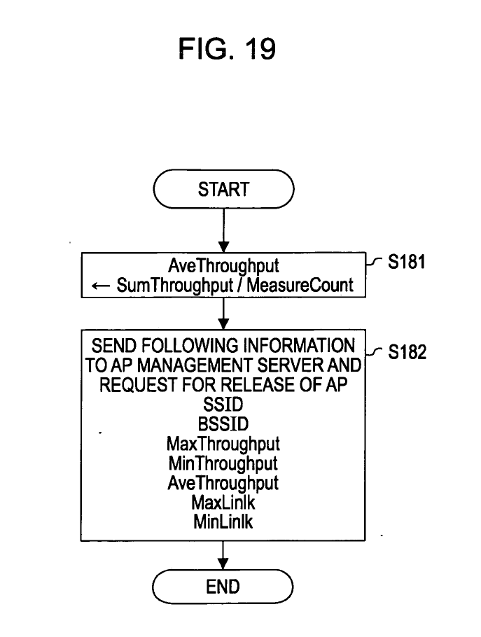

FIG. 19 is a flowchart showing the procedure for the access point release processing performed on the client 21 side for releasing access point bandwidth reservation after streaming processing is finished, which is executed in step S107 of the flowchart shown in FIG. 13.

First, using the streaming log, the client 21 calculates the average throughput AveThroughput (step S181).

Then, the client 21 requests the AP management server 13 to release the access point for which bandwidth reservation has been made in step S104 for performing the streaming processing (step S182).

The release request describes the SSID and BSSID of the access point, the channel used by the access point, the maximum link speed (MaxLink), the minimum link speed (MinLink), the maximum throughput (MacThroughput), the average throughput (AveThroughput), and the minimum throughput (MinThroughput).

Upon reserving the access point release request from the client 21, the AP management server 13 activates the processing routine shown in FIG. 9, and releases the bandwidth reservation for the access point that is requested to be released. Specifically, the bandwidth released by the client 21 originating the request is added to the available bandwidth of the corresponding record in the management AP reservation list, or the record is deleted from the list (as previously described). By the AP management server 13 thus rewriting the reserved bandwidth for the access point on the management AP reservation list (see Table 1), it becomes possible again for other clients to use the bandwidth of the access point that has been reserved.

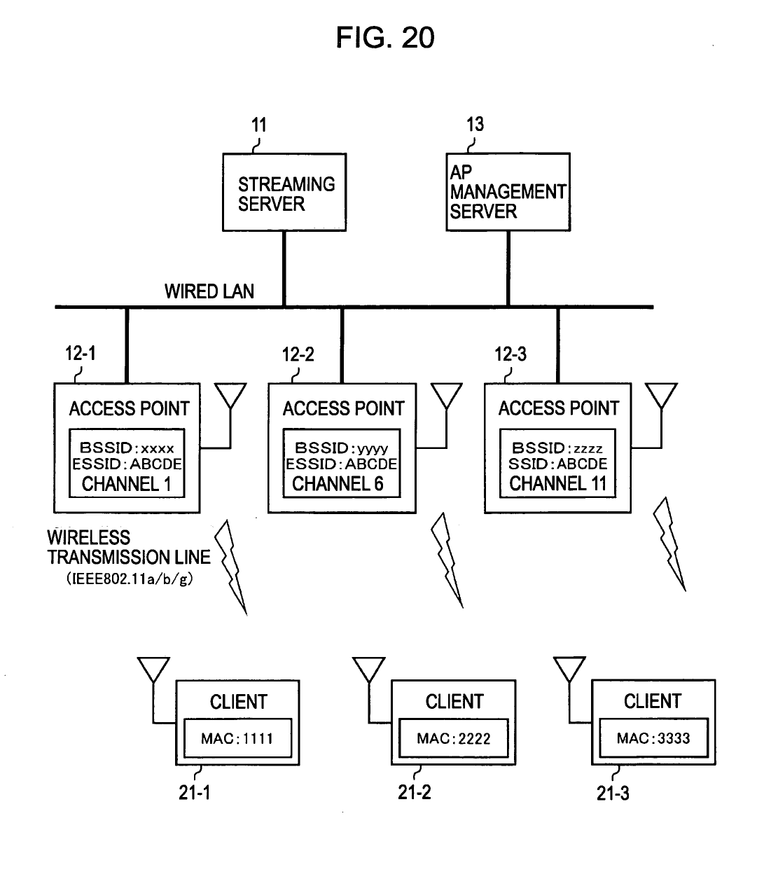

FIG. 20 shows a modification of the communication system shown in FIG. 1. The difference from the arrangement shown in FIG. 1 is that all the access points 12-1, 12-2, and 12-3 are set to the same SSID. It should be noted, however, that the respective access points 12-1, 12-2, and 12-3 use different channels. In this case, apparently, setting processing with respect to one access point suffices as the access point setting on the client 21 side.

Normally, when the client 21 makes connection to the access point 12, this is performed by designating the ESSID and WEP (since the channel selection is left to the physical layer, it is not possible to perform channel designation on the user level). Accordingly, in order to realize the system shown in FIG. 20, a function is required whereby the channel is designated on the client 21 side to connect to the access point 12.

The communication system shown in FIG. 20 differs from the system shown in FIG. 1 in the selection processing for an access point that can be reserved, the bandwidth reservation request to the AP management server 13, and the connection processing with the access point. The procedure for these processing will be described below.

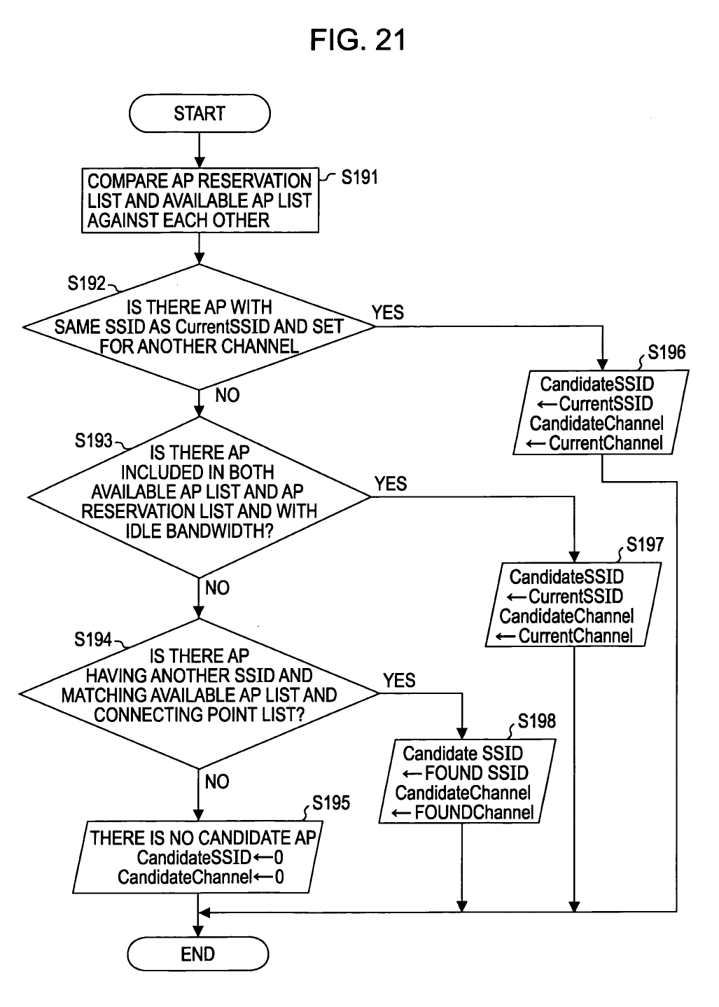

FIG. 21 is a flowchart showing the procedure for the selection processing for an access point that can be reserved, which is performed by the client 21 in the communication system shown in FIG. 20.

First, the client 21 compares the notification AP reservation list (see Table 2) acquired from the AP management server 13 against the available AP list (see Table 5) created by the local station through the procedure shown in FIG. 14 (step S191).

Then, the client 21 checks whether or not a record of an access point for which there is no entry in the notification AP reservation list is present in the available AP list (step S192). In this case, it is checked whether or not there is an access point that has the same SSID as CurrentSSID and is set to another channel. If such an access point could be found, the client 21 sets the access point as the reservation candidate access point (that is, substitutes CurrentSSID into CandidateSSID, and substitutes the found channel into CandidateChannel) (step S196), returns this as a return value to the client that has requested the processing routine, and ends this processing routine.

If an access point having the same SSID as CurrentSSID and set to another channel could not be found (step S192), then it is checked whether or not there is an access point included in both of the available AP list and the notification AP reservation list but with having idle available bandwidth (step S193). If such an access point could be found, the client 21 sets the access point as the reservation candidate access point (that is, substitutes CurrentSSID into CandidateSSID, and substitutes the found channel into CandidateChannel) (step S197), returns this as a return value to the client that has requested the processing routine, and ends this processing routine.

If an access point that can secure a sufficient bandwidth for performing streaming processing could not be found from the available AP list (step S193), it is further checked whether or not there is an access point having another SSID and matching the available AP list and the connection AP list (step S194). If such an access point could be successfully found, the client 21 sets the access point as the reservation candidate access point (that is, substitutes CurrentSSID into CandidateSSID, and substitutes the found channel into CandidateChannel) (step S197), returns this as a return value to the client that has called up the processing routine, and ends this processing routine.

On the other hand, if a suitable access point could not be found in any of the determination blocks S192 to S194, the available access point=0 (that is, CurrentSSID and 0 are substituted into CandidateSSID and CandidateChannel, respectively) is returned as a return value to the client that has requested the processing routine (step S195), and this processing routine is ended.

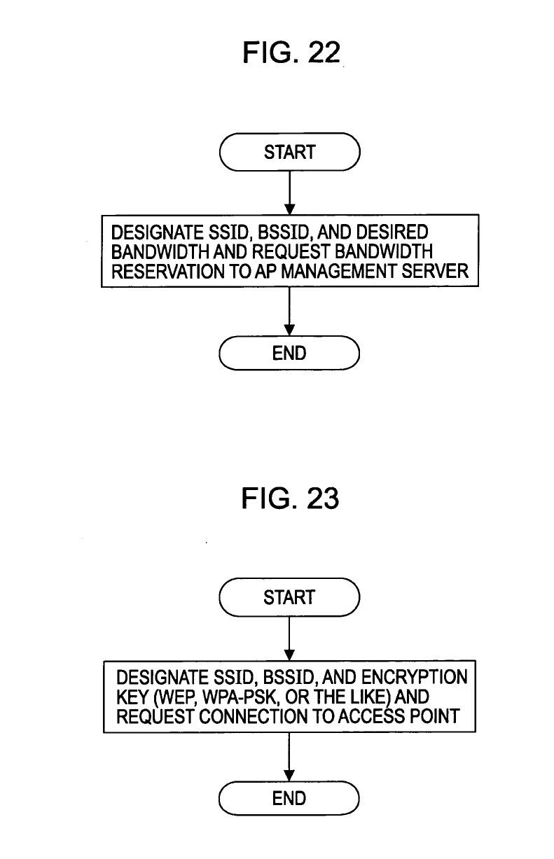

FIG. 22 is a flowchart showing the procedure for a bandwidth reservation request made to the AP management server 13 by the client 21 in the communication system shown in FIG. 20.

While in the system shown in FIG. 1 the client 21 makes a bandwidth reservation request to the AP management server 13 by designating SSID and the desired bandwidth (as previously described), in this system, the client 21 makes a bandwidth reservation request to the AP management server 13 by designating SSID and BSSID, and the desired bandwidth.

Further, FIG. 23 is a flowchart showing the procedure for the client 21 to connect to the access point 12 in the communication system shown in FIG. 20.

While in the system shown in FIG. 1 the client 21 makes a connection request to the access point 12 by designating SSID and the encryption key (WEP key, WPS-PSK, or the like) (as previously described), in this system, the client 21 makes a connection request to the access point 12 by designating SSID and BSSID, and the encryption key (WEP key, WPS-PSK, or the like).

The present invention has been described in the foregoing with reference to the specific embodiments thereof. However, it is obvious that persons skilled in the art can make various alterations and substitutions to the embodiments without departing from the scope of the present invention.

While in this specification the description is directed to the case of performing moving picture streaming between the streaming server and the client, the scope of the present invention is not limited to this. The present invention is also applicable to the case where, under a wireless communication environment in which a plurality of access points are installed, high load data transmission or data transmission involving bandwidth reservation is to be performed between the server and the client through the intermediation of the access points.

That is, the present invention has been disclosed by way of illustration, and hence the description of the specification should not be construed restrictively. The scope of the present invention should be defined by the appended claims.

What is claimed is:

1. A wireless communication system in which a plurality of access points are installed and data provided by a server on a wired transmission line is transmitted wirelessly to a client via an access point, comprising:
access point reservation managing means for managing access point reservation information relating to a reservable bandwidth for each of the access points;
available access point managing means for managing available access point information relating to access points to which a client wishing to perform data communication with the server can connect;
access point selecting means for selecting an access point to which the client connects when performing data communication with the server, on the basis of the access point reservation information relating to the reservable bandwidth for each of the access points, and the available access point information relating to the access points that can be connected to from the client;
bandwidth reservation requesting means for making a reservation request to the access point reservation managing means to use, from within a reservable bandwidth for the selected access point, a bandwidth required when the client performs data communication with the server; and
data communication means for performing data communication between the server and the client by using the bandwidth reserved for the access point.

2. The wireless communication system according to claim 1, further comprising access point release requesting means for requesting, when data communication between the server and the client by the data communication means is finished, the access point reservation managing means to release the bandwidth that is reserved for the access point to perform the data communication.

3. The wireless communication system according to claim 1 or 2, wherein in response to a request made by the bandwidth reservation requesting means to reserve the bandwidth for the access point, the access point reservation managing means subtracts the bandwidth requested for reservation from the reservable bandwidth for the access point, and in response to the request made by the access point release requesting means to release the bandwidth that has been reserved for the access point, the access point reservation managing means adds the released bandwidth to the reservable bandwidth for the access point.

4. The wireless communication system according to claim 1, wherein the access point reservation managing means include maximum effective speed managing means for managing a maximum effective speed with respect to each of the access points.

5. The wireless communication system according to claim 1, wherein:
the data communication means includes communication log acquiring means for acquiring a communication log at the time of data communication between the server and the client; and
the maximum effective speed managing means sets the maximum effective speed on the basis of a wireless transmission mode adopted by the access point, and updates the maximum effective speed in accordance with the communication log.

6. The wireless communication system according to claim 4, wherein:
the access point reservation managing means subtracts the bandwidth requested to be reserved for the access point by the bandwidth reservation requesting means from one of the maximum effective speed of the access point and a current reservable bandwidth for the access point and updates the access point reservation information; and
the access point reservation managing means adds the reserved bandwidth for the access point which is requested to be released by the access point release requesting means to the current reservable bandwidth for the access point and updates the access point reservation information.

7. The wireless communication system according to claim 1, wherein the available access point managing means further includes available access point searching means for searching for access points to which the client wishing to perform data communication with the server can connect.

8. The wireless communication system according to claim 1, wherein:
the access point reservation managing means provides notification access point reservation information relating to a reservable bandwidth for each of the access points, in response to a request from the available access point managing means;
the available access point managing means manages, on the basis of the notification access point reservation information provided from the access point reservation managing means, the available access point information relating to a bandwidth available for each of the access points to which the client can connect; and
the access point selecting means selects, on the basis of the available access point information and a bandwidth required when the client performs data communication with the server, an access point to which the client is to connect.

9. The wireless communication system according to claim 1, wherein the access point reservation managing means is configured as a host device on the wired transmission line.

10. The wireless communication system according to claim 1 or 2, wherein each client includes the available access point managing means, the access point selecting means, the bandwidth reservation requesting means, and the access point release requesting means.

11. An access point management device for performing access point management in a wireless communication environment in which a plurality of access points are installed and data provided by a server on a wired transmission line is transmitted wirelessly to a client via an access point, comprising:
access point reservation managing means for managing access point reservation information relating to a reservable bandwidth for each of the access points;
notification access point reservation information providing means for providing, in response to a request from the client, notification access point information relating to a reservable bandwidth for each of the access points;
first access point reservation information updating means for updating the access point reservation information in response to a bandwidth reservation request for an access point from the client; and
second access point reservation information updating means for updating the access point reservation information in response to a release request for a bandwidth reserved for an access point from the client.

12. The access point management device according to claim 11, wherein:
the first access point reservation information updating means subtracts, in response to a bandwidth reservation request for an access point, the bandwidth requested to be reserved from a reservable bandwidth for the access point;
the second access point reservation information updating means adds, in response to a request for releasing an access point that has been reserved, the released bandwidth to the reservable bandwidth for the access point.

13. The access point management device according to claim 11, further comprising maximum effective speed managing means for managing a maximum effective speed with respect to each of the access points.

14. The access point management device according to claim 13, wherein:
the data communication means includes communication log acquiring means for acquiring a communication log at the time of data communication between the server and the client; and
the maximum effective speed managing means sets the maximum effective speed on the basis of a wireless transmission mode adopted by the access point, and updates the maximum effective speed in accordance with a communication log.

15. The access point management device according to claim 13, wherein:
the access point reservation managing means subtracts the bandwidth requested to be reserved for the access point from one of the maximum effective speed of the access point and a current reservable bandwidth for the access point and updates the access point reservation information; and
the first access point reservation information updating means adds the reserved bandwidth for the access point which is requested to be released to the current reservable bandwidth for the access point and updates the access point reservation information.

16. An access point management method for performing access point management in a wireless communication environment in which a plurality of access points are installed and data provided by a server on a wired transmission line is transmitted wirelessly to a client via an access point, comprising:
an access point reservation managing step of managing access point reservation information relating to a reservable bandwidth for each of the access points;
a notification access point reservation information providing step of providing, in response to a request from the client, notification access point reservation information relating to a reservable bandwidth for each of the access points;
a first access point reservation information updating step of updating the access point reservation information in response to a bandwidth reservation request for an access point from the client; and
a second access point reservation information updating step of updating the access point reservation information in response to a release request for a bandwidth reserved for an access point from the client.

17. A wireless communication device which operates as a client in a wireless communication environment in which a plurality of access points are installed and data provided by a server on a wired transmission line is transmitted wirelessly to a client via an access point, comprising:
available access point managing means for managing available access point information relating to access points to which connection can be made;
access point selecting means for selecting an access point to which connection is made when performing data communication with the server, on the basis of information relating to a reservable bandwidth for each of the access points, and the available access point information relating to the access points to which connection can be made;
bandwidth reservation requesting means for making a request for reserving, from within a reservable bandwidth for the selected access point, a bandwidth required when performing data communication with the server; and
data communication means for performing data communication with the server by using the bandwidth reserved for the access point.

18. The wireless communication device according to claim 17, further comprising access point release requesting means for requesting, when data communication with the server by the data communication means is finished, release of the bandwidth that is reserved for the access point for the data communication.

19. The wireless communication device according to claim 17, wherein the data communication means further includes communicating log acquiring means for acquiring a communication log at the time of data communication between the server and the client.

20. The wireless communication device according to claim 17, wherein the available access point managing means further includes available access point searching means for searching for access points to which connection can be made.

21. The wireless communication device according to claim 17, wherein:
the available access point managing means manages available access point information relating to an available bandwidth by acquiring notification access point reservation information relating to a reservable bandwidth for each of the access points, and connecting, on the basis of the notification access point reservation information, to each of the access points to which connection can be made; and
the access point selecting means selects, on the basis of the available access point information and a bandwidth required when performing data communication with the server, an access point to which connection is to be made.

22. A wireless communication method for realizing operation as a client in a wireless communication environment in which a plurality of access points are installed and data provided by a server on a wired transmission line is transmitted wirelessly to a client via an access point, comprising:
an available access point managing means step of managing available access point information relating to access points to which connection can be made;
an access point selecting step of selecting an access point to which connection is made when performing data communication with the server, on the basis of information relating to a reservable bandwidth for each of access points, and the available access point information relating to the access points to which connection can be made;
a bandwidth reservation requesting step of making a request for reserving, from within a reservable bandwidth for the selected access point, a bandwidth required when performing data communication with the server;
a data communication step of performing data communication with the server by using the bandwidth reserved for the access point; and
an access point release requesting step of requesting, when data communication with the server in the data communication step is finished, release of the bandwidth that is reserved for the access point for the data communication.

23. A computer program written in a computer-readable format, for causing access point management processing to be executed on a computer system in a wireless communication environment in which a plurality of access points are installed and data provided by a server on a wired transmission line is transmitted wirelessly to a client via an access point, the computer program causing the computer system to execute;
an access point reservation management process of managing access point reservation information relating to a reservable bandwidth for each of the access points;
a notification access point reservation information providing process of providing, in response to a request from the client, notification access point information relating to a reservable bandwidth for each of the access points;
a first access point reservation information updating process of updating the access point reservation information in response to a bandwidth reservation request for an access point from the client; and
a second access point reservation information updating process of updating the access point reservation information in response to a release request for a bandwidth reserved for an access point from the client.

24. A computer program written in a computer-readable format, for executing processing causing the computer program to operate as a client on a computer system in a wireless communication environment in which a plurality of access points are installed and data provided by a server on a wired transmission line is transmitted wirelessly to a client via an access point, the computer program causing the computer system to execute;
an available access point managing process of managing available access point information relating to access points to which connection can be made;
an access point selecting process of selecting an access point to which connection is made when performing data communication with the server, on the basis of information relating to a reservable bandwidth for each of access points, and the available access point information relating to the access points to which connection can be made;
a bandwidth reservation requesting process of making a request for reserving, from within a reservable bandwidth for the selected access point, a bandwidth required when performing data communication with the server;
a data communication process of performing data communication with the server by using the bandwidth reserved for the access point; and
an access point release requesting process of requesting, when data communication with the server by the data communication means is finished, release of the bandwidth that is reserved for the access point for the data communication.

25. A wireless communication system in which a plurality of access points are installed and data provided by a server on a wired transmission line is transmitted wirelessly to a client via an access point, comprising:
an access point reservation managing section managing access point reservation information relating to a reservable bandwidth for each of the access points;
an available access point managing section managing available access point information relating to access points to which a client wishing to perform data communication with the server can connect;
an access point selecting section selecting an access point to which the client connects when performing data communication with the server, on the basis of the access point reservation information relating to the reservable bandwidth for each of the access points, and the available access point information relating to the access points that can be connected to from the client;
a bandwidth reservation requesting section making a reservation request to the access point reservation managing section to use, from within a reservable bandwidth for the selected access point, a bandwidth required when the client performs data communication with the server; and
a data communication section performing data communication between the server and the client by using the bandwidth reserved for the access point.

26. An access point management device for performing access point management in a wireless communication environment in which a plurality of access points are installed and data provided by a server on a wired transmission line is transmitted wirelessly to a client via an access point, comprising:
an access point reservation managing section managing access point reservation information relating to a reservable bandwidth for each of the access points;
a notification access point reservation information providing section providing, in response to a request from the client, notification access point information relating to a reservable bandwidth for each of the access points;
a first access point reservation information updating section updating the access point reservation information in response to a bandwidth reservation request for an access point from the client; and
a second access point reservation information updating section updating the access point reservation information in response to a release request for a bandwidth reserved for an access point from the client.

27. A wireless communication device which operates as a client in a wireless communication environment in which a plurality of access points are installed and data provided by a server on a wired transmission line is transmitted wirelessly to a client via an access point, comprising:
an available access point managing section managing available access point information relating to access points to which connection can be made;
an access point selecting section selecting an access point to which connection is made when performing data communication with the server, on the basis of information relating to a reservable bandwidth for each of the access points, and the available access point information relating to the access points to which connection can be made;
a bandwidth reservation requesting section making a request for reserving, from within a reservable bandwidth for the selected access point, a bandwidth required when performing data communication with the server; and
a data communication section performing data communication with the server by using the bandwidth reserved for the access point.
